(19) United States
(12) Patent Application Publication
(10) Pub. No.: US 2012/0206405 A1
(43) Pub. Date: Aug. 16, 2012

(54) OPERATING MODULE OF DISPLAY DEVICE WITH TOUCH PANEL AND OPERATING METHOD THEREOF

(75) Inventors: Jae Il Kim, Gyunggi-do (KR); Sung Taek Lim, Gyunggi-do (KR); Jong Young Lee, Gyunggi-do (KR); Hyun Jun Kim, Gyunggi-do (KR)

(73) Assignee: SAMSUNG ELECTRO-MECHANICS CO., LTD., Gyunggi-do (KR)

(21) Appl. No.: 13/396,032

(22) Filed: Feb. 14, 2012

(30) Foreign Application Priority Data
Feb. 16, 2011 (KR) 1020110013792

(51) Int. Cl. G06F 3/044; G06F 3/045; G06F 3/041

(52) U.S. Cl. 345/174; 345/173

(57) ABSTRACT

Disclosed herein is an operating module of a display device with a touch panel. The operating module includes a touch input unit for a user to input a value through a touch unit; a pattern input unit to which the same pattern image as patterns of a transparent electrode formed on the touch panel having the touch input unit is input; a control unit coupling each image signal into a single image signal according to an output value having a complementary pattern image value with the pattern image value input to the pattern input unit and an output value according to the input of the touch input unit; and an output unit outputting an image signal by the control unit.

### CROSS REFERENCE TO RELATED APPLICATION

This application claims the benefit of Korean Patent Application No. 10-2011-0013792, filed on Feb. 16, 2011, entitled “Operating Module of Display Device with Touch Panel and Operating Method Thereof,” which is hereby incorporated by reference in its entirety into this application.

### BACKGROUND OF THE INVENTION

1. Technical Field

The present invention relates to an operating module of a display device with a touch panel and an operating method thereof.

2. Description of the Prior Art

In accordance with the growth of computers using a digital technology, devices assisting computers have also been developed, and personal computers, portable transmitters and other personal information processors execute processing of text and graphics using a variety of input devices such as a keyboard and a mouse. While the rapid advancement of an information-oriented society has been widening the use of computers more and more, it is difficult to efficiently operate products using only a keyboard and mouse currently serving as an input device. Therefore, the necessity for a device that is simple, has minimum malfunction, and is capable of easily inputting information has increased.

In addition, current techniques for input devices have progressed toward techniques related to high reliability, durability, innovation, designing and processing beyond the level of satisfying general functions. To this end, a touch panel has been developed as an input device capable of inputting information such as text, graphics, or the like.

The touch panel is a tool that is coupled with the display device to permit a user to select desired information while watching the display device. The display device is a device displaying an image. There are various types of display devices, such as a liquid crystal display (LCD), a plasma display panel (PDP), other flat panel display, a cathode ray tube (CRT), or the like. However, a touch panel is used as an input apparatus so as to easily use the information by being used together with the above-mentioned image display device. As one type of the touch panel, there may be an analog resistive type, a digital resistive type, a capacitive type, a saw type, an infrared type, or the like. The above-mentioned touch panel and display panel are each manufactured separately and are generally bonded to each other by a double-sided adhesive tape, or the like.

FIG. 1 is a diagram schematically showing a display assembly according to the prior art in which the touch panel is attached to the display device. Referring to FIG. 1, in a display assembly 100 according to the prior art, a display device 120 is bonded to a touch panel 110 by an adhesive 130. Further, a user wanting to use the above-mentioned display assembly 100 selects menus while watching images displayed on the display device 120 and presses the touch panel 110 by an input unit such as the user's finger, or the like, to use image information.

However, the display device with the touch panel has a problem of general visibility of the touch panel as patterns of a transparent electrode of the touch panel are visualized. In particular, the patterns of the transparent electrode made of a conductive polymer that are formed on the touch panel may degrade the visualization of the touch panel due to its own visibility. FIGS. 2 and 3 are diagrams showing a cross-sectional view and a plan view of the transparent electrode made of the conductive polymer according to the prior art. As shown in FIG. 2, a space 230 is formed between the patterns of the transparent electrode 210 and as shown in FIG. 3, the patterns of the transparent electrode may be relatively visualized clearly due to unique colors of the conductive polymer In the prior art, the patterns of the transparent electrode of the touch panel are visualized as they are, thereby greatly degrading the general visibility of the touch panel.

### SUMMARY OF THE INVENTION

The present invention has been made in an effort to provide an operating module of a display device with a touch panel and an operating method thereof capable of improving general visibility of the touch panel by controlling contrast, colors, or the like, on an output screen through a control unit of a display device with the touch panel.

According to a preferred embodiment of the present invention, there is provided an operating module of a display device, including: a touch input unit for a user to input a value through a touch unit; a pattern input unit to which the same pattern image as patterns of a transparent electrode formed on the touch panel having the touch input unit is input; a control unit coupling each image signal into a single image signal according to an output value having a complementary pattern image value with the pattern image value input to the pattern input unit and an output value according to the input of the touch input unit; and an output unit outputting an image signal by the control unit.

The touch panel may be a capacitive type or a resistive type.

The display device may include LCD, LED, OLED, or CRT.

The transparent electrode may be made of a conductive polymer.

The conductive polymer may include poly-3,4-ethylene dioxy thiophene/polystyrene sulfonate (PEDOT/PSS), polyaniline, polyacetylene, and polyphenylene vinylene.

According to another preferred embodiment of the present invention, there is provided an operating method of a display device with a touch panel, including: inputting a pattern image of a transparent electrode formed on a touch panel to a pattern input unit; inputting an input value to a touch input unit through a touch unit by a user; coupling, by a control unit, each image signal into a single image signal according to an output value having a complementary pattern image value with a pattern image value input to the pattern input unit and an output value according to the input of the touch input unit; and outputting the single image signal output by a control unit from an output unit.

The touch panel may be a capacitive type or a resistive type.

The display device may include LCD, LED, OLED, or CRT.

The transparent electrode may be made of a conductive polymer.

The conductive polymer may include poly-3,4-ethylene dioxy thiophene/polystyrene sulfonate (PEDOT/PSS), polyaniline, polyacetylene, and polyphenylene vinylene.

### BRIEF DESCRIPTION OF THE DRAWINGS

The patent or application file contains at least one drawing executed in color. Copies of this patent or patent application publication with color drawing(s) will be provided by the U.S. Patent and Trademark Office upon request and payment of the necessary fee.

FIG. 1 is a diagram showing a display assembly according to the prior art.

FIG. 2 is a cross-sectional view of a touch screen panel including patterns of a transparent electrode according to the prior art.

FIG. 3 is a plan view clearly showing the patterns of the transparent electrode of the touch screen panel according to the prior art.

FIG. 4 is a cross-sectional view of a display device with a touch panel according to the embodiment of the present invention.

FIG. 5 is a diagram of an operating module of the display device with the touch panel according to the preferred embodiment of the present invention.

FIG. 6 is a diagram showing an L*a*b color system.

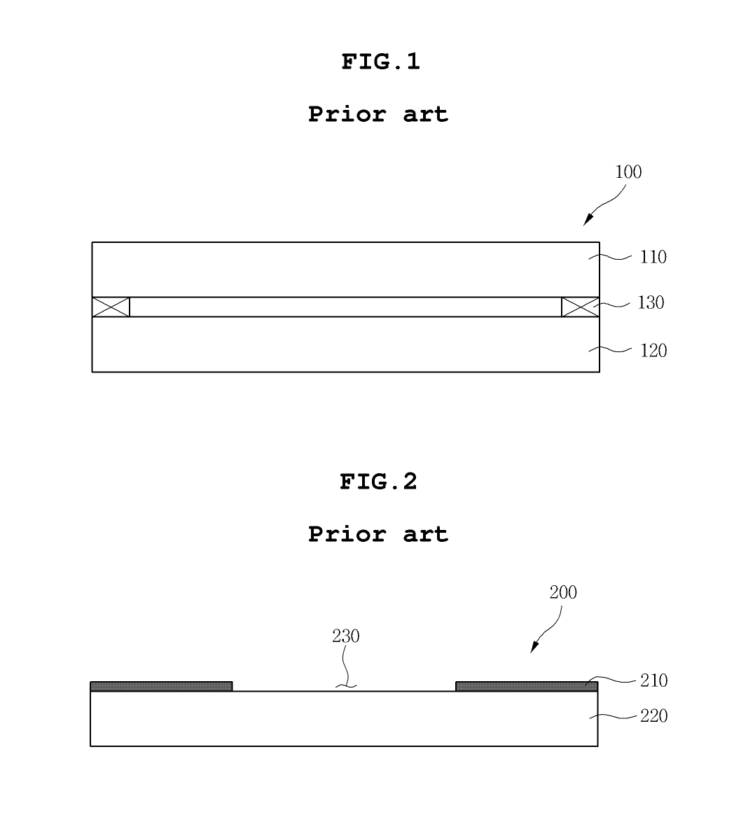

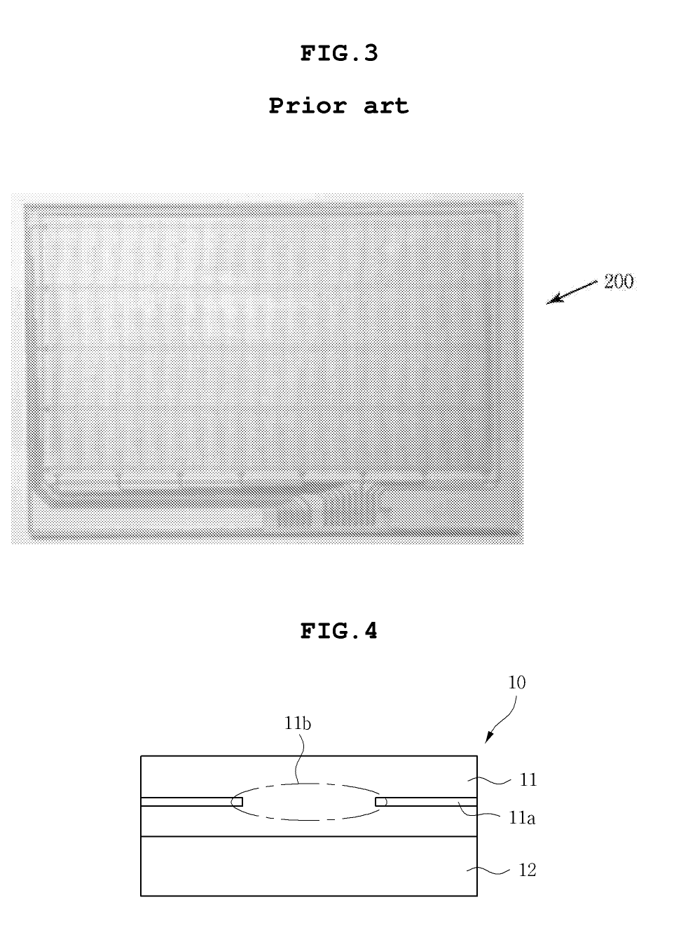

### DESCRIPTION OF THE PREFERRED EMBODIMENTS

Various objects, advantages and features of the invention will become apparent from the following description of embodiments with reference to the accompanying drawings.

The terms and words used in the present specification and claims should not be interpreted as being limited to typical meanings or dictionary definitions, but should be interpreted as having meanings and concepts relevant to the technical scope of the present invention based on the rule according to which an inventor can appropriately define the concept of the term to describe most appropriately the best method he or she knows for carrying out the invention.

The above and other objects, features and advantages of the present invention will be more clearly understood from the following detailed description taken in conjunction with the accompanying drawings. In the specification, in adding reference numerals to components throughout the drawings, it is to be noted that like reference numerals designate like components even though components are shown in different drawings. In the description, the terms “first,” “second,” and so on are used to distinguish one element from another element, and the elements are not defined by the above terms. In describing the present invention, a detailed description of related known functions or configurations will be omitted so as not to obscure the gist of the present invention.

Hereinafter, preferred embodiments of the present invention will be described in detail with reference to the accompanying drawings.

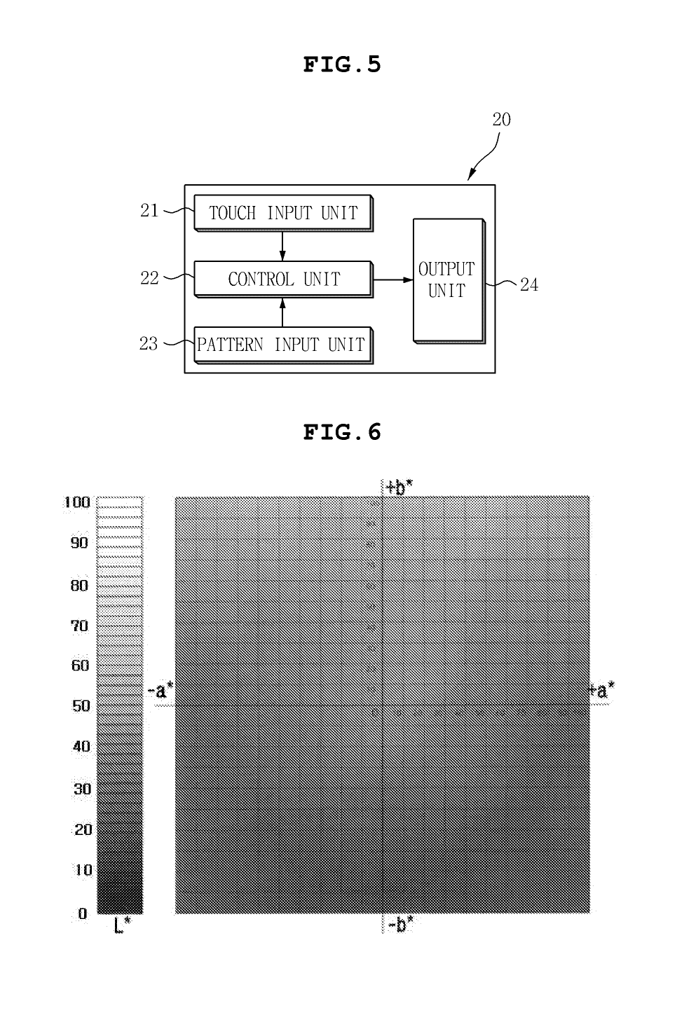

FIG. 4 is a cross-sectional view of a display device with a touch panel according to the embodiment of the present invention and FIG. 5 is a diagram of an operating module of the display device with the touch panel according to the preferred embodiment of the present invention. An operating module 20 of a display device 12 with the touch panel 11 according to the present invention includes a touch input unit 21 for a user to input a value through a touch unit, a pattern input unit to which the same pattern image as patterns of a transparent electrode 11a formed on the touch panel having the touch input unit 21 is input, a control unit 22 coupling each image signal into a single image signal according to an output value having a complementary pattern image value with the pattern image value input to the pattern input unit 23 and an output value according to the input of the touch input unit 21, and an output unit 24 outputting an image signal by the control unit.

Generally, in the touch panel 11, the transparent electrode 11a is formed on one surface of the transparent substrate (not shown) and a pattern process of the transparent electrode 11a is performed in the case of a digital type among a capacitive type and a resistive type. A coordinative system of an X axis and a Y axis is formed in a 1-layer type or a 2-layer type by patterning the transparent electrode 11a. Coordinative values of touched positions are measured by a touch input to the patterned transparent electrode 11a to represent a user desired output value.

The transparent substrate forming the touch panel 11 may use any material having a predetermined strength without being particularly limited. For example, polyethylene terephthalate (PET), polycarbonate (PC), polymethyl methacrylate (PMMA), polyethylene naphthalate (PEN), or the like, may be used. In addition, since the transparent electrodes 11a and 12 are formed on one surface of the transparent substrate, one surface of the transparent substrate 11 is subjected to high frequency processing, primer processing, or the like, so as to improve adhesion between the transparent substrate and the transparent electrode 11a, thereby forming a surface treatment layer (not shown).

The transparent electrode 11a serves to recognize coordinates in a control unit (not shown) by generating signal when being touched by a user and is formed on one surface of the transparent substrate. Here, the transparent electrode 11a is made of a conductive polymer. An example of the conductive polymer may include Poly-3,4-ethylene dioxy thiophene/polystyrene sulfonate (PEDOT/PSS), polyaniline, polyacetylene, polyphenylene vinylene, or the like, but is not limited thereto. As the transparent electrode 11a of the preferred embodiment of the present invention is made of the conductive polymer, visibility of the touch panel 11 may be degraded due to visualization of the patterns of the transparent electrode 11a. The degradation in visibility of the touch panel 11 according to the visualization of the pattern of the transparent electrode 11a may equally occur as in the digital type even when the capacitive touch screen and the resistive type. That is, when the transparent electrode 11a is made of the conductive polymer, the pattern portion of the transparent electrode 11a may be relatively more visualized than the circumference thereof due to the unique colors of the conductive polymer. That is, the general visibility of the touch panel 11 is degraded due to a space 11b between the patterns of the transparent electrode 11a and the difference in colors generated between the transparent electrode 11a.

Therefore, the preferred embodiment of the present invention is to solve the visibility problem through a software process of the display device 10 with the touch panel. In particular, in order to reduce the visibility of the patterns of the transparent electrode 11a generated due to the unique colors of the conductive polymer used as the transparent electrode 11a, all the image signals are output by coupling the images of the same or corresponding colors. As a result, the space 11b between the patterns of the transparent electrode 11a is added with colors corresponding to the transparent electrode 11a, such that the general visualization of the pattern is reduced, thereby improving the visibility of the touch panel 11.

The touch input unit 21 is a unit that permits a user to input a desired value through the touch unit. In particular, the touch unit may be varied according to whether the touch panel 11 is a capacitive type or a resistive type, or the like. However, a kind of the touch panel 11 is not limited thereto. As a result, the touch unit may be applied to various types of touch panels when there is a problem in the visibility of the touch panel due to the patterns of the transparent electrode 11a, unbalance of colors, or the like, by other causes, or the like. The preferred embodiment of the present invention described a case in which the transparent electrode 11a is made of the conductive polymer.

The pattern input unit 23, which is formed in the display device 12, is a unit that inputs the pattern image of the transparent electrode 11a causing the visibility problem of the touch panel 11. The function of the pattern input unit 23 is not limited by the term thereof. Therefore, the pattern input unit may input the image of a shape and a color, or the like, that degrades the visibility of the other touch panel 11. The general visibility of the touch panel 11 is improved by first inputting the image reducing the visibility to the pattern input unit 23 and controlling the complementary image with the image, that is, arranging unbalance colors to be balanced or controlling a portion in which is relatively darker or brighter formed to be brighter or darker. The output image with the generally improved visibility may be visible by previously setting the image reducing or hindering the visibility on the touch panel 11 coupled with the display device 12 to the pattern input unit 23 and reflecting the set image to an image output later.

The control unit 22 combines an input value by the touch input unit 21 and the image input by the pattern input unit 23 to perform calculation so as to output a generally balanced image. In outputting the value input through the touch panel 11, the general visibility may be improved by outputting the image signal of the complementary image with the pattern of the transparent electrode previously input to the pattern input unit 23. For example, when the transparent electrode 11a is made of the conductive polymer, in order to reduce the visualization of the pattern according to the unique colors of the conductive polymer, the output image corresponding to the space 11b between the patterns of the transparent electrode 11a needs to be combined with the general output image. In detail, the preferred range of the corresponding color is proposed through the L*a*b color system in consideration of the colors of the conductive polymer.

The L*a*b color system (see FIG. 6) is produced so as to represent color errors and small color differences in paint, paper, plastic, textile, or the like, in pigment industry fields. The L*a*b color system that is results researched so as to more approximate to human emotion is produced based on an opponent-color theory between Yellow-Blue and Green-Red sensing colors by human and is one of color spaces defined by CIE in 1976. In the L*a*b color system, L* represents brightness, a* and b* represent a color direction as in a coordinate of FIG. 6. That is, +a* represents a red direction, −a represents a green direction, +b* represents a yellow direction, and −b* represents a blue direction. A center is an achromatic color and a chroma is increased when being progressed from a center to an outside while a* and b* values are increased. When a mixing color is performed based on characteristics of the color system, the errors of colors are easily represented and the transform direction of colors may be easily estimated, which have been commonly all over the world.

The range of colors of the output image formed so as to correspond to the space 11b between the patterns of the transparent electrode 11a based on the color system may be formed by the colors in a range in which L* is 90 to 96, a* is −2.0 to 2.0, and b* is −2.0 to 4.0 in the L*a*b color system. However, the range of colors is not limited to the above range and thus, may be formed to have the colors in an appropriate range according to materials and characteristics forming the transparent electrode 11a.

The output unit 24 is a unit that combines the input value of the touch input unit 21 and the pattern image input to the pattern input unit 23 by the control unit 22 to appropriately control the image signal, thereby outputting the final output value. The output unit 24 may be formed in various types according to whether the display device 12 uses any kind of devices and therefore, is not limited to a special apparatus or configuration.

As described above, the touch panel 11 in the digital type according to the preferred embodiment of the present invention among the capacitive type and the resistive type may be used so as to solve the visibility problem of the touch panel 11 according to the visualization of the pattern of the transparent electrode 11a. However, it is apparent that the preferred embodiment of the present invention may be applied to the visibility problem caused by the pattern of the transparent electrode 11a and the touch panel 11 or other causes by performing the software image control through the display device 12. In this case, the display device 12 includes LCD, LED, OLED, or CRT and various device configurations outputting the image may correspond thereto and is not limited the listed device.

An operating method of the display device 10 with the touch panel according to the preferred embodiment of the present invention includes inputting the pattern image of the transparent electrode 11a formed on the touch panel to the pattern input unit 23, inputting the input value to the touch input unit 21 through the touch unit by the user, coupling, by the control unit 22, each image signal into the single image signal according to the output value having the complementary pattern image value with the pattern image value input to the pattern input unit 23 and the output value according to the input of the touch input unit 21; and outputting the single image signal output by the control unit 22 from the output unit 24.

First, the inputting of the pattern image of the transparent electrode 11a formed on the touch panel 11 to the pattern input unit 23 is performed. The pattern image of the transparent electrode 11a formed on the touch panel 11 is input to the pattern input unit 23 of the display device 12. The visibility problem of the touch panel 11 is solved by visualizing the patterns of the transparent electrode 11a of the touch panel 11. When there are the pattern of the transparent electrode 11a as well as the shape and colors hindering the visibility of the touch panel 11, the visibility of the touch panel 11 may be improved by the method of inputting the image and outputting the complementary image with the image, as described below.

Next, the inputting of the input value to the touch input unit 21 through the touch unit by the user is performed. The inputting of the desired value to the touch panel 11 by the user using the touch unit matching the shape or the type of the touch panel 11 is performed. The desired output image is displayed on the screen through the display device 12 according to the input value to the touch panel 11.

Next, the coupling of each image signal according to the output value having the pattern image value complementarily corresponding to the pattern image value input to the pattern input unit 23 and the output value according to the input of the touch input unit 21 into the single image signal by the control unit 22 is performed. When the image is output according to the value input by the touch input unit 21, the final output image is shown in consideration of the pattern image of the transparent electrode 11a hindering the visibility of the touch panel 11 input to the pattern input unit 23. The control unit 22 integrates and calculates the value input by the touch input unit 21 and the pattern image value input by the pattern input unit 23. For example, the visibility of the final output image may be more improved according to the input value of the touch input unit 21 by the calibration of color or brightness so as to improve the complementary image with the pattern image input to the pattern input unit 23, that is, the visibility.

In particular, when the transparent electrode 11a is made of the conductive polymer, the output image may be controlled to the range of the color according to the L*a*b color system as described above. The visibility of the touch panel 11 may be improved by combining the images at the position corresponding to the space 11b between the patterns of the transparent electrode 11a. The range of the colors of the output image may be formed by colors in the range in which L* is 90 to 96, a* is −2.0 to 2.0, and b* is −2.0 to 4.0 in the L*a*b color system. However, the range of colors is not limited to the above range and thus, may be formed to have the colors in an appropriate range according to materials and characteristics forming the transparent electrode 11a.

Finally, the process in which the single image signal by the control unit 22 is output by the output unit 24 is performed. As described above, the generally improved output image may be shown by combining two image signals through the control unit 22.

As set forth above, the preferred embodiments of the present invention can improve the general visibility of the display device with the touch panel.

In addition, the preferred embodiments of the present invention can improve the general visibility of the touch panel by reducing the visualization of the patterns of the transparent electrode of the touch panel through the image signal control of the display device with the touch panel.

Further, the preferred embodiments of the present invention can improve the general visibility of the touch panel by accurately outputting the complementary image with the visualized pattern image of the transparent electrode by previously inputting the pattern image of the transparent electrode of the touch panel to the display device.

In addition, the preferred embodiments of the present invention can solve the problem of the visibility of various touch panels by solving the visibility problem of various pattern images of the transparent electrode, or the like, by the software control of the output image of the display device.

Although the preferred embodiments of the present invention have been disclosed for illustrative purposes, they are for specifically explaining the present invention and thus an operating module of a display device with a touch panel and an operating method thereof according to the present invention are not limited thereto, but those skilled in the art will appreciate that various modifications, additions and substitutions are possible, without departing from the scope and spirit of the invention as disclosed in the accompanying claims. Accordingly, any and all modifications, variations or equivalent arrangements should be considered to be within the scope of the invention, and the detailed scope of the invention will be disclosed by the accompanying claims.

What is claimed is:

1. An operating module of a display device with a touch panel, comprising:
a touch input unit for a user to input a value through a touch unit;
a pattern input unit to which the same pattern image as patterns of a transparent electrode formed on the touch panel having the touch input unit is input;
a control unit coupling each image signal into a single image signal according to an output value having a complementary pattern image value with the pattern image value input to the pattern input unit and an output value according to the input of the touch input unit; and
an output unit outputting an image signal by the control unit.

2. The operating module of a display device with a touch panel as set forth in claim 1, wherein the touch panel is a capacitive type or a resistive type.

3. The operating module of a display device with a touch panel as set forth in claim 1, wherein the display device includes LCD, LED, OLED, or CRT.

4. The operating module of a display device with a touch panel as set forth in claim 1, wherein the transparent electrode is made of a conductive polymer.

5. The operating module of a display device with a touch panel as set forth in claim 4, wherein the conductive polymer includes poly-3,4-ethylene dioxy thiophene/polystyrene sulfonate (PEDOT/PSS), polyaniline, polyacetylene, and polyphenylene vinylene.

6. An operating method of a display device with a touch panel, comprising:
inputting a pattern image of a transparent electrode formed on a touch panel to a pattern input unit;
inputting an input value to a touch input unit through a touch unit by a user;
coupling, by a control unit, each image signal into a single image signal according to an output value having a complementary pattern image value with a pattern image value input to the pattern input unit and an output value according to the input of the touch input unit; and
outputting the single image signal output by a control unit from an output unit.

7. The method as set forth in claim 6, wherein the touch panel is a capacitive type or a resistive type.

8. The method as set forth in claim 6, wherein the display device includes LCD, LED, OLED, or CRT.

9. The method as set forth in claim 6, wherein the transparent electrode is made of a conductive polymer.

10. The method as set forth in claim 9, wherein the conductive polymer includes poly-3,4-ethylene dioxy thiophene/polystyrene sulfonate (PEDOT/PSS), polyaniline, polyacetylene, and polyphenylene vinylene.
